(19) United States
(12) Patent Application Publication
(10) Pub. No.: US 2020/0202266 A1
(43) Pub. Date: Jun. 25, 2020

(54) ACCOUNTING USING AN EVENT NETWORK MODEL

(71) Applicant: John Rankin, Morgantown, WV (US)

(72) Inventor: John Rankin, Morgantown, WV (US)

(21) Appl. No.: 16/720,550

(22) Filed: Dec. 19, 2019

Related U.S. Application Data
(60) Provisional application No. 62/781,875, filed on Dec. 19, 2018.

(51) Int. Cl. G06Q 10/06; G06Q 20/20; G06Q 40/00

(52) U.S. Cl. CPC G06Q 10/0633; G06Q 40/12; G06Q 10/06315; G06Q 20/209

(57) ABSTRACT

Systems and methods for providing accounting using an event network model are provided. Event data is received from one or more event recorders representing the occurrence of an event. Said event data comprises an actor, a location, and a time of the event. Each event is stored at a central repository, associated with an initiator and a terminator, and connected to at least one stored event.

### CROSS-REFERENCE TO RELATED APPLICATION

This application claims the benefit of U.S. Provisional Application No. 62/781,875 filed Dec. 19, 2018, the disclosures of which are hereby incorporated by reference as if fully restated.

### TECHNICAL FIELD

Exemplary embodiments of the present invention relate generally to systems and methods for accounting using an event network model.

### BACKGROUND AND SUMMARY OF THE INVENTION

Accounting, from a historical point of view, is confronted with issues that relate to the storage and management of accounting information, based upon preconceptions left over from the 15th century. Standard accounting reports are generally produced using a standardized double-entry system that conforms to the accepted general ledger.

External methods for manipulation are necessary to make this limited system of storage useful for more than simply standard business accounting and rational modern business operations; significant innovation would be required to allow our business world to effectively deal with the requirements of the international market.

Accounting procedures are fundamentally based upon the use of a general ledger, and several other supporting accounting books. These forms of accounting have translated to the modern practice, as a progressive and incremental process. Each new accounting practice is built upon a previous one, generally without concern for more modern facilities and methods of computerization. Radical innovation demands a departure from this stepwise process and requires a fundamental redesign and augmentation that departs from traditional practice.

There are three exemplary general areas where accounting information can and is used. A first is Generally Accepted Accounting Principles (“GAAP”). It is invaluable for business organizations to maintain accounting information that can be readily used for standardized reporting. The balance sheet income statement and statement of cash flow, to name some examples, represent well understood presentations that have been standardized by GAAP. With this standardization comes the ability for outside individuals and organizations to evaluate and measure business performance. If there were not a rational agreed upon method for the production of balance sheets and income statements, for example, it would be a daunting task to compare organizations for purposes of investment. Furthermore, banking and finance companies would expend inordinate resources understanding business operations and performance.

Accounting information and systems collect and develop data that can be readily expressed into these standardized presentations. Since observation by stockholders and financiers is often of paramount importance and must be accessible on a continual and timely basis, inventories, payments, receivables, and other such valuable information is stored and updated in a GAAP format. This allows for the production of accounting statements without delays due to transformation.

A second area is taxes. There are a wide range of taxes that any organization is responsible for and while accounting for payment of such taxes is not often required daily, the ability to prepare and report for tax purposes is extremely important. However, the accounting rules for GAAP differ significantly from that of Federal and State requirements; and therefore, data is often harvested from GAAP accounting data and reformed into palatable expressions for tax purposes.

These differences can significantly affect the volume and skill level of the work required to produce what is necessary. Amortization and depreciation schedules, for example, differ along with the recognition of some income categories. Furthermore, specialized deductions and tax abatements can further confuse the available information. Since accounting information is stored in a format that is not optimal for taxation, specialized personnel are generally required to manage and generate the accurate reporting requirements.

A third area is operations. All organizations are designed to operate in various ways and accounting information is required to ensure that the organization's operations are effective. The inventories, payables, receivables, and cash journals are all instrumental for daily operations; however, there are a number of areas that are poorly served by these standard internal formats.

One of the most important issues that affects operation information is the confusion created by the use of accrual-based accounting. The idea behind this method is to recognize revenue when it is owed rather than when it is received, and recognize expenses when they are owed rather than when they are paid. While this method is effective for standardized accounting, it does not allow for a clear picture of actual cash availability.

Depending upon complex accounting methods at play, it is possible to completely misjudge current and available assets and drive an organization into serious problems. Forcing organizations to operate using an accrual method can produce unnecessary demands upon lending vehicles to make up the difference between actual resources and accrued ones.

Specific organizational needs cluster around data that determines how the company is operating. These elements cannot easily be standardized and are often industry specific. By forcing data collection into a mold that is designed for balance sheet and income statement production, details necessary for operational observation are often lost.

As an example, the consumption of raw materials used during manufacturing might well be tallied, but its consumption rate, waste production, labor to manufacturing indicators, and rate of production given industrial facilities must be accounted for in some axillary way. These types of organizational requirements are highly important and effectively an afterthought to the needs of accounting.

Forecasting of sales, manufacturing, logistics, and economic effectors are generally absent from traditional accounting methods. These types of complex formulations must be produced externally and through a process of data extraction and augmentation by supplemental information. Often, entire additional databases must be maintained and supplemented with accounting records which are difficult to extract.

Without effective forecasting, operations can become haphazard as sales and revenue is often unpredictable. The future of an organization is dependent upon the availability of the most accurate and reliable information concerning trends and their influence over production and manufacturing.

Operational modeling is an area of control over operations that is almost always absent due to its complex resource requirements. However, the ability to determine how processes will function given changes in the availability of raw materials and economic constraints can mean the continued operation of an organization. The requisite modeling software and specialized databases which would be required for such a system are not generally available in standard accounting systems.

Some accounting calculations have been automated by the use of software and other automated data processing. However, the use of software and automated data processing presents its own challenges, such as but not limited to, the large system effect.

The large system effect occurs in processing systems that are designed to handle a specific set of conditions of finite size and complexity. When presented with conditions larger and more complex than expected, those systems no longer operate efficiently—or at all. To illustrate this effect, imagine a small town with one main cross street at an intersection having a stop light that is timed to change on one-minute intervals to allow traffic to flow efficiently based on the size of the expected traffic volume. Under normal operating conditions, the design works effectively, as the number of cars entering and leaving the city from any given direction is a volume that fits within the design parameters. However, if the volume of traffic using the cross streets increases beyond the amount that can be handled during a one-minute traffic stop, congestion will likely occur. The congestion will continue to exacerbate if the excess traffic volume does not decrease below the maximum number of cars that can pass through the intersection during the one-minute window. Therefore, if new cars entering the town continue to exceed the expected, designed capacity, the traffic system is likely to ultimately fail. The failure of a system in this manner is due to large system effects.

This type of systematic problem may be referred to as a non-linear system, moving from ordered operation into chaos. In the previous example, the system moved from an ordered operation into chaos because the growth of traffic is non-linear and the progression of the system operation is repetitive and does not correct for the change in non-linear conditions. While one would hope that a system could be designed to handle a multitude of changing and expanding criteria, the reality is far less certain because systems can only truly be designed to handle what can be reasonably envisioned.

The chaotic operations produced by the large system effect do not often occur in a smooth or increasing movement from order to chaos. Chaotic order tends to occur as one or more catastrophic breakpoints in system behavior. Even slow changes in a system's control parameters may result in a sudden shift to catastrophe. This type of phenomenon occurs, for example, in the water-ice transition at sea level pressure: as temperature decreases below the freezing temperature, water displays a transition from a liquid state to a solid state. Systems that may potentially experience such large system effects may exhibit sudden catastrophic behavior at intervals and without an observable smooth transition.

Without operational modeling, organizations cannot avoid falling victim to logistic and procedural failures due to the large-system effect. Systems of standardized accounting provide no inherent support to avoid these catastrophic issues. Therefore, what is needed are systems and methods for accounting using an event network model.

The present invention comprises systems and methods for accounting using an event network model. In this way, applications of accounting information may be achieved through a radical reorganization of accounting methods. By abandoning traditional methods and reengineering the fundamental collection elements, it is possible to provide a process where all three areas of information required may be satisfied without compromising the effectiveness, accuracy, delivery, and reliability of the presented results.

By organizing accounting into a careful network of events and recording real time actualization of those events, rather than simplistically organized ledger systems, it is possible to build a dynamic network event model of the organization. Accounting processes become the careful recording of event occurrences and data is stored in a complete network database of interrelated event actions. This network database may be extrapolated into any envisioned accounting, forecasting, management, or economic presentation. This presentation may be more accurate, complete, and reliable. Additionally, this presentation may be available in real time. Furthermore, the complex database may be augmented with hypothetical information to project and predict process operations within the system recorded.

The present invention may provide an accurate, working, real time model of the organization. The model may comprise the level of detail necessary to recreate, carefully account, and report all aspects of the organization's operation. By continually feeding real time event information into a free formed network database, the system and method may effectively provide a microcosm of the organization which may be utilized for any imagined accounting operation.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a simplified block diagram modeling exemplary event network connection types in accordance with the present invention;

FIG. 2 is a simplified diagram of modeling exemplary event elements of FIG. 1;

FIG. 3 is a simplified block diagram modeling exemplary event movements in accordance with the present invention;

FIG. 4 is a simplified block diagram modeling exemplary event recorders in accordance with the present invention; and

FIG. 5 is a simplified block diagram modeling exemplary disgorgement of information modeled by the systems and methods of FIG. 1-4.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

As the described system and method of accounting is radically different from other approaches of accounting, this detailed description is divided into four main sections for clarity: an explanation of the structure and operation of the event network model; the process used to populate the event network model; the process where the event network model disgorges its information; and a discussion of how this accounting method is applied to the three required areas of accounting.

Event Network Model.

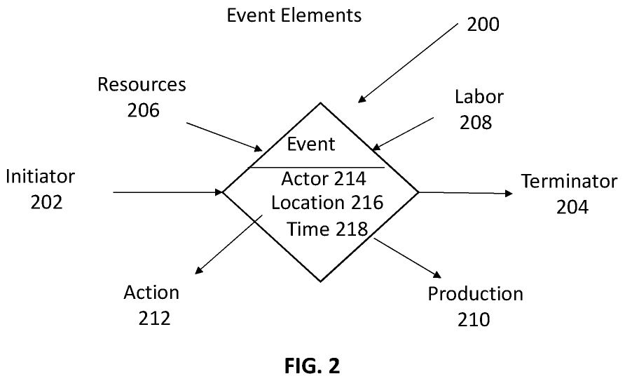

An event 200, as illustrated in FIG. 2, may comprise a unit of action 202. Each event 200 may comprise at least three main effectors: the actor 214, the location 216, and the time 218. However, any number of effectors of any type are contemplated. In exemplary embodiments, all events 200 have an initiator 202 and a terminator 204, and all events 200 consume resources 206 and labor 208 in their operation. Furthermore, in exemplary embodiments, all events 200 either produce items 210, generate further actions 212, some combination thereof, or the like. All aspects of any business or organization may be defined in terms of delineable events 200 where the events 200 may be initiated by other internal events 200 or external initiators 202. However, in other exemplary embodiments, only some aspects of a business or organization may be so defined. Stated another way, the initiator 202 may be another event 200, an external initiator 202, some combination thereof, of the like. Generally, the greater the level of granularity the more accurate the overall accuracy of the accounting. The process of accounting becomes a system and method of carefully recording actual events 200 rather than merely the accounting of legered monitoring units being moved from category to category.

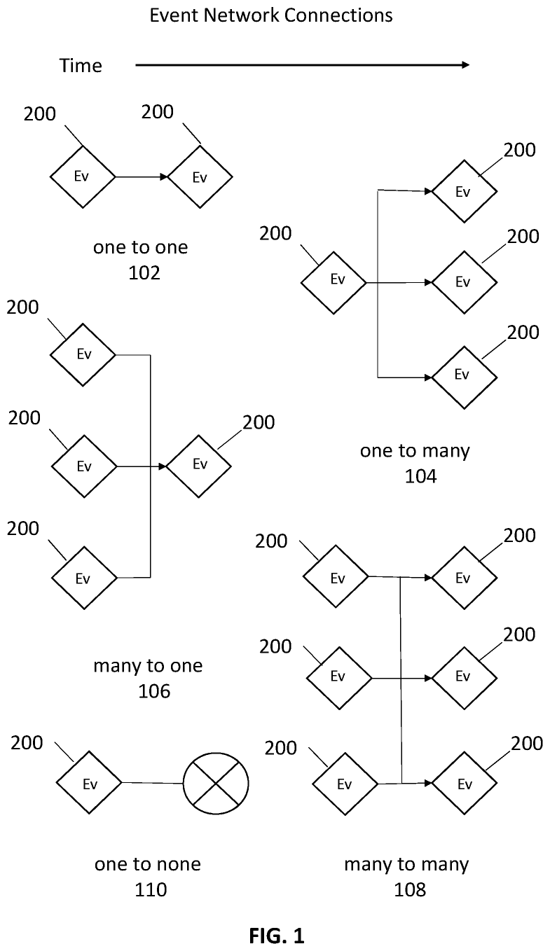

Events 200 may be related to additional events 200 and form a network of overall events 200 that is expressed by the presentation of the network itself. Exemplary types of connections are illustrated by FIG. 1, where five exemplary relationships are described. It is notable that the term “event” is sometimes abbreviated herein and/or in the accompanying figures as “Ev”. Of course, the provided relationships are merely exemplary and are not intended to be limiting. Any number of relationships connecting any number of events 200 in any number of ways are contemplated.

One to one 102 may be an event 200 that produces an action 212 or a production 210 that initiates another single event 200. One to many 104 may be an event 200 that produces an action 212 or a production 210 that initiates multiple other events 200. There is no limit to the number of events 200 that can be created in this fashion. In this way, an accurate and complete representation of organizational actions may be developed. Many to one 106 may be multiple events 200 that combine their actions 212 or productions 210 into a single event 200. This is a common occurrence for fabrication processes, for example without limitation, where multiple elements are conjoined to produce a final action 212 or product 210. Many to many 108 may permit several events 200 to produce several additional actions 212 and/or productions 210. There is an endless variety of possibilities between events 200 that have only to reflect actual actions 212. One to none 110 may be utilized, for example without limitation, to terminate a line of production 210 where no more action 212 or productions 210 may be necessary.

This general system and methodology may hereinafter also be referred to generally as the Event Network Model. The Event Network Model may be different from previously designed accounting systems which generally use currency and units of inventory to develop central ledgers. In a radical transformation of accounting practice, an active real time event network model may act as the complete data repository for an entirely new process of accounting. Information is organized into discrete events 200 and each event's 200 relationship to one another other is recorded and modeled. All other elements of accounting may be produced by additional processes applied against this organizational model.

Population of Event Network Model.

There are a wide variety of techniques that may be used to populate the Event Network Model, examples of which are illustrated and described herein to provide an exemplary utilizable process. However, these are merely exemplary and not intended to be limiting. The end result of any process of population may provide a complete description of the organization in operation. However, in other exemplary embodiments, only a portion of, or a limited number of, operations of the organization may be modeled. While data collected to assemble the specific events 200 may be produced across a variety of platforms, fundamental elements of the event 200 may be standardized. For example, without limitation, the actor 214, location 216, and time 218 of event may be provided using commonly agreed upon identifiers and synchronized timing information.

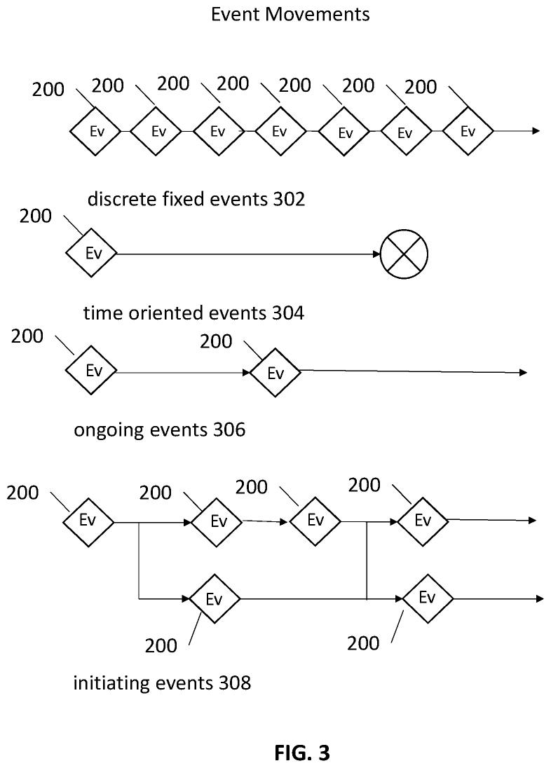

There are four exemplary groups of events that may be referred to herein as movements, as illustrated in FIG. 3. Discrete fixed events 302 may describe an action 212 or process 210 that occurs once and is not necessarily connected with any other event 200. Examples, without limitation, of these types of events 200 are activities that are related to fixed business costs, such as lighting, heat, air-conditioning, and the like. These events 200 must generally occur regardless of cause and effect business activities and are not related to labor 208, however resources 206 are consumed. Therefore, such events 200 should be documented in exemplary embodiments. Time-oriented events 304 may be events 200 that are initiated based upon timed events 200. These may be, for example without limitation, additional fixed costs or business processes that are time-oriented. Examples, without limitation, of these types of events 200 include a fabrication process that takes place over time. It is possible that such events 200 are not time-initiated, such as for example without limitation, turning on shift lighting, but take a length of time that is quantifiable like cooking or baking, for example without limitation. Ongoing events 306 may be events 200 which continue over time and produce actions 212 and products 210. Examples of such events 200 may include, without limitation, an assembly line or other process of continual production 210 where actions 212, products 210, or additional events 200 are produced. Initiating events 308 may be events 200 that create or spawn other events 200 where the initiation of the event 200 comes from the outcome of a previous event 200. Examples of this type of movement may include, for example without limitation, ordering food in a restaurant that produces a number of additional events 200 necessary to satisfy the order. However, these events 200 may be the direct casual effect of the order of food. In other words, initiating events 308 may be events 200 which produce additional events 200.

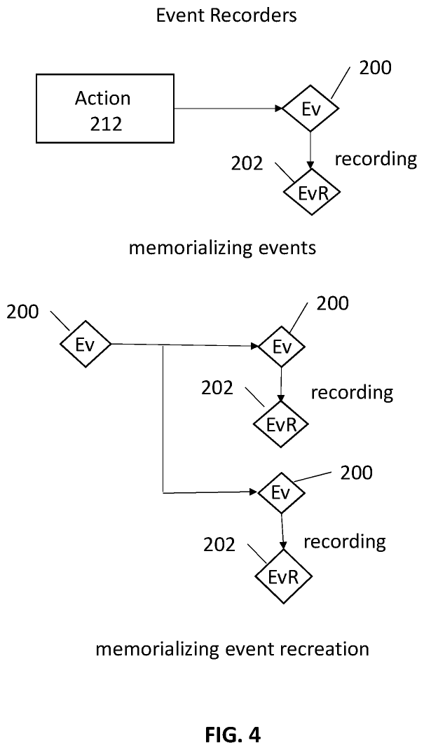

The population of the event network model may occur through a systematic process of simple event recording. By developing a system and method to record events, either as they occur or when they are created, a complete image of the organization may be achieved. An example of such recording is shown in FIG. 4. When an action 212, that is a definable event 200 occurs a record 202 may be produced and collected in a central repository 205. It is notable that in the accompanying figures the event record is sometimes abbreviated herein as “EvR”. The central repository may be a database, sever, other electronic storage device, or the like. In other exemplary embodiments, the recordation may be made across multiple devices. This record may be an augmentation to any real-world system that is in operation. For example, a point of sale system may experience a great number of events 200 and develop a great number of event records 202 during its operation and function.

Disgorging Information from the Event Network Model.

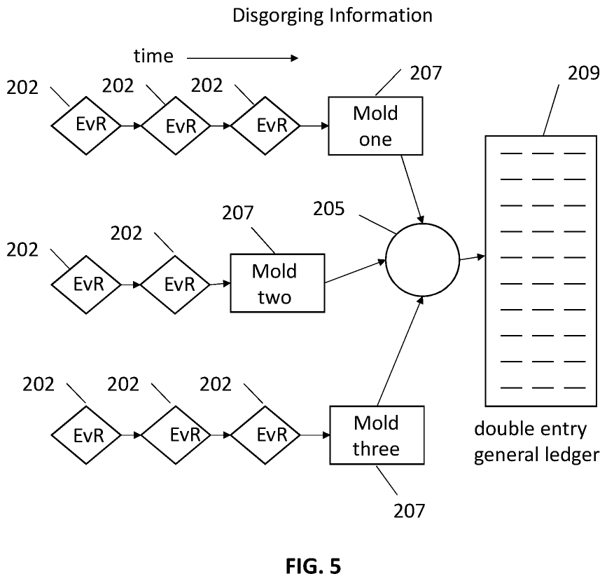

Information stored in an event network model may be harvested into any form necessary for management, display, reporting, or observation. This system and method may be effectuated by developing a mold or filter 207 that is adjusted for the type of events 200 that it retrieves and produces. A list of recorded events 200, organized by time, for example without limitation, may be fed through one or more molds 207 to drive the development or creation of the required information. FIG. 5 illustrates an example, without limitation, for producing a standard general ledger double entry accounting ledger 209 based upon the event network model.

As long as data from ques of recorded events are processed on the same time sequence, the resulting output may accurately reflect the underlining information using the desired output format. In the example from FIG. 5, as each event record 202 is processed, the general ledger 209 may be advanced in its accounting as it would have in the real world. In this way, a substantially real-time accounting may be produced. However, such is not required and the general ledger 209 may be updated in any time interval.

The event network model may comprise a collection of recorded events 202 that relate to each other through modeled cause and effect relationships. By storing this collection of recorded events 202, the operation of the originating organization may be preserved. This preserved image of the company in operation may be turned into any analysis that is desired since the model may be examined through an infinite number of molds 207. Therefore, by storing the operation of the company, rather than merely a ledger of its accounting, all aspects of information may be utilized from the same source. Furthermore, all three areas of accounting: GAAP, taxes and operation, can be achieved from this central storage innovation.

The system and method described herein may comprise one or more electronic storage devices 205 which comprise executable software instructions and one or more processors for executing said executable software instructions. The execution of said executable software instructions may configure the processor to perform one or more functions described herein.

An exemplary method for accounting using an event network model comprises the steps of receiving event data from one or more event recorders representing the occurrence of an event, storing the event data in a central repository comprising one or more stored events, and connecting the event to at least one of the one or more stored events. The event may be associated with an initiator of the event. The event may be associated with a terminator of the event. The event data may be comprised of: an actor, a location, and/or a time of the event. The event data may describe: a discrete fixed event, a time oriented event, an ongoing event, and/or an initiating event.

Each event may be associated with additional inputs. The inputs may be consumed during the operation of the event. The event data may be associated with the input of at least one or more resources. The event data may be associated with the input of at least one or more labor actions. Each event may be associated with additional outputs. The outputs may be produced by the operation of the event. The event data may be associated with the production. A production may be a manufacture, a construction, and/or an additional process. The event data may be associated with an action. The action may be an additional operation, event, and/or an interaction. The event data may be connected with other stored events. The relationship of these connections may be: one to one, one to many, many to one, one to none, or many to many.

One or more events and their data may be extracted from the event network model. The data may be collected by a mold of events into a predetermined presentation format. The presentation format may be an electrical data file, a printed report, visual display, and/or a transfer or exchange of the collected information. The collected extraction, or disgorgement, may be: in a double entry accounting format, a form usable for taxation calculations, and/or a specialized organization useful for operation, analysis, or forecasting.

One or more events may be recorded by the action of: a single action, a number of actions, a temple of actions, a series of unrelated actions, and/or an expected or anticipated action. The event data may be populated in the network model: in real time, by historical recreations, and/or by prerecorded network actions. The simulation of the activities of the network model can be: projected, replayed, predicted, and/or tested. The inputs, resources, and labor costs may be simulated. A time frame for operation may be replayed, with alternative inputs. The extracted or disgorgement may represent the simulation operation. The event data may remain unchanged by the simulation.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may be personal computers, smartphone, tablets, databases, servers, or the like. The electronic connections and transmissions described herein may be accomplished by wired or wireless means.

What is claimed is:

1. A method for accounting using an event network model, said method comprising the steps of:
receiving event data from one or more event recorders representing the occurrence of an event, wherein said event data comprises an actor, a location, and a time of the event;
storing the event at a central repository comprising one or more stored events;
associating an initiator with the event;
associating a terminator with the event; and
connecting the event to at least one of the one or more stored events.

2. The method of claim 1 wherein:
said event data further comprises at least one resource.

3. The method of claim 1 wherein:
said event data further comprises at least one labor input.

4. The method of claim 1 further comprising the steps of:
associating the event with an action.

5. The method of claim 1 further comprising the steps of:
associating the event with a production.

6. The method of claim 1 wherein:
the event is connected to the at least one stored event in a one to one fashion.

7. The method of claim 1 wherein:
the at least one stored event comprises at least two stored events; and
the event is connected to the at least two stored events in a one to many fashion.

8. The method of claim 1 wherein:
the at least one stored event comprises at least two stored events; and
the event is connected to the at least two stored events in a many to one fashion.

9. The method of claim 1 wherein:
the at least one stored event comprises at least three stored events; and
the event is connected to the at least three stored events in a many to many fashion.

10. The method of claim 1 further comprising the steps of:
generating a report comprising a double entry general ledger, wherein said double entry ledger comprises event data from the event and the at least one stored event.

11. The method of claim 1 further comprising the steps of:
applying a filter to the event.

12. A method for accounting using an event network model, said method comprising the steps of:
receiving event data from a number of event recorders representing the occurrence of events, wherein said event data comprises an actor, a location, a time, an initiator, and a terminator for each event;
storing said event data as a number of events at a database in electronic communication with each of the event recorders, wherein the database comprises a number of stored events;
electronically associating each of the number of events stored at the database with at least one of the number of stored events at the database such that each of the number of events and each of the number of stored events are electronically connected to at least one other of the number of stored events or one of the number of events; and
upon receipt of user input at an electronic device, generating a report for display at the electronic device of the number of events and the number of stored events stored at the database and the connections between each of the number of events and the number of stored events

13. The method of claim 12 wherein:
the event recorders comprise point of sale systems.

14. The method of claim 12 further comprising the steps of:
associating each of the number of events with at least one action, at least one production, at least one resource, and at least one labor input.

15. The method of claim 12 further comprising the steps of:
applying a filter to each of the number of events.

16. The method of claim 12 wherein:
the report comprises a double entry general ledger.

17. The method of claim 12 wherein:
each of the number of events is connected to at least one of the number of stored events in a fashion selected from the group consisting of: one to one, one to many, many to one, one to none, and many to many.

18. A system for accounting using an event network model comprising:
a report generator comprising an electronic display;
a number of event recorders, each of which are configured to record event data representing occurrence of events, wherein said event data comprises an actor, a location, a time, an initiator, and a terminator for each event, and wherein at least one of said number of event recorders comprises a point of sale system; and
a server in electronic communication with each of the number of event recorders and the report generator, wherein said server comprises one or more processors and one or more electronic storage devices comprising a number of stored events and executable software, which when executed by the one or more processors configures the one or more processors to:
receive the event data from the event records representing the occurrence of the events;
connect each of the received events with at least one of the number of stored events; and
upon receipt of user input, generate for display at the electronic display, a report comprising a double entry general ledger comprising the event data and representing the connections between each of the received events at the number of stored events.

19. The system of claim 18 wherein:
each of the events is connected to at least one of the number of stored events in a fashion selected from the group consisting of: one to one, one to many, many to one, one to none, and many to many.

20. The system of claim 18 wherein:
the event data further comprises at least one action, at least one production, at least one resource, and at least one labor input for each event.

21. A method for accounting using an event network model, said method comprising the steps of:
receiving event data from one or more event recorders representing the occurrence of an event, wherein said event is associated with an initiator of the event, wherein said event is associated with a terminator of the event, wherein said event data is comprised of: an actor, a location, and/or a time of the event, and wherein said event data describes: a discrete fixed event, a time oriented event, an ongoing event, or an initiating event;
storing the event data in a central repository comprising one or more stored events; and
connecting the event to at least one of the one or more stored events.

22. The method of claim 21 wherein:
each event is associated with additional inputs; and,
the inputs are consumed during the operation of the event.

23. The method of claim 22 wherein:
said event data is associated with the input of at least one or more resources.

24. The method of claims 22 wherein:
said event data is associated with the input of at least one or more labor actions.

25. The method of claim 24 wherein:
each event is associated with additional outputs; and,
the outputs are produced by the operation of the event.

26. The method of claim 25 wherein:
said event data is associated with a production; and,
the production is a manufacture, a construction, and/or an additional process.

27. The method of claim 25 wherein:
said event data is associated with an action; and,
the action is an additional operation, event, and/or an interaction.

28. The method of claim 21 wherein:
the connection between the event and the at least one of the one or more stored events is selected from the group consisting of: one to one, one to many, many to one, one to none, or many to many;

29. The method of claim 21 wherein:
one or more events and associated data are configured for extraction from the event network model;
the data is collected by a mold of events into a predetermined presentation format;
the presentation format can be an electrical data file, a printed report, visual display, and/or a transfer or exchange of the collected information;
the collected extraction, or disgorgement, is provided in a format selected from the group consisting of: double entry accounting, a form usable for taxation calculations, and specialized organization useful for operation, analysis, or forecasting.

30. The method of claim 29 wherein:
one or more events are recorded by an action selected from the group consisting of:
a single action, a number of actions, a temple of actions, a series of unrelated actions, and/or an expected or anticipated action;
the event data is populated in the network model by a technique selected from the group consisting of: real time, historical recreations, and prerecorded network actions.

31. The method of claim 29 wherein:
the simulation of the activities of the network model are selected from the group consisting of: projected, replayed, predicted, and tested;
the inputs, resources, and labor costs are configured to be simulated;
a time frame is provided where operations are capable of being replayed, with alternative inputs;
the extraction or disgorgement represents the simulation operation; and
the event data remains unchanged by the simulation.
